(19) United States
(12) Patent Application Publication
(10) Pub. No.: US 2018/0148845 A1
(43) Pub. Date: May 31, 2018

(54) Metal Component and Method for the Production Thereof

(71) Applicant: Nemak, S.A.B. de C.V., Garcia (MX)

(72) Inventors: Wolfgang Kühn, Lauter-Bernsbach (DE); Annett Bretschneider, Zwonitz (DE); Rolf Gosch, Thalheim bei Wels (AT); Bernhard Stauder, Wels (AT); Jurij Gontarev, Linz (AT)

(21) Appl. No.: 15/572,219

(22) PCT Filed: May 6, 2016
(86) PCT No.: PCT/IB2016/000587

§ 371 Date: Nov. 7, 2017

(30) Foreign Application Priority Data
May 7, 2015 (DE) 10 2015 107 171.1

(51) Int. Cl. C23D 5/08; C03C 8/14; C03C 8/20; C23D 7/00; C23D 13/00

(52) U.S. Cl. CPC C23D 5/08; C03C 8/14; C03C 2207/08; C23D 7/00; C23D 13/00; C03C 8/20

(57) ABSTRACT

A metal component which has a face which during use is thermally or mechanically more highly loaded than the environment thereof and which is at least partially covered with a glaze or enamel layer and a method for the production thereof. The metal component requires no specific limitations during the thermal processing operation and nonetheless ensures optimum protection for the surfaces which are highly loaded during use. The glaze or enamel layer contains, with respect to the enamel frit used to produce the enamel coating, from 2 to 35% by weight of an admixture of particles which consist of at least one material from glass, organic plastics materials, and synthetic oxide mixtures or melts, which each have a thermal expansion coefficient of a maximum of 50×10⁻⁷ K⁻¹ and a melting temperature of at least 500° C.

The invention relates to a metal component which has a face which during use is thermally or mechanically more highly loaded than the environment thereof, wherein this face is at least partially covered with a glaze or enamel layer in order to protect against the thermal or mechanical loads. In particular the metal component is a cast component which is cast from a metal casting material.

The invention also relates to a method for producing a metal component, in particular a cast component, with a face which at least at one location which is subjected to a high thermal alternating load during use, is covered with an enamel or glaze layer.

As explained in detail in the Article “Möglichkeiten and Grenzen der Emaillierung von Leichtmetallen” (Possibilities and Limitations of Enamel Coating of Light Metals) by Dr.-Ing. Wolfgang Kühn, published in Oberflächen/Surfaces Polysurfaces No. 2/09, Pages 6-9, the enamel coating of components, which comprise light materials, such as aluminium, magnesium and titanium materials, is becoming increasingly significant. In this instance, from a technical viewpoint, the protection of the component surfaces from corrosive attacks has previously been of primary importance.

As further set out in the mentioned article, enamel coatings are glass layers which were adapted above all in terms of the melting temperature and the thermal expansion coefficients to the carrier materials which were provided for them. They combine the properties of a glass surface with the material and processing properties of metals. In contrast to other coatings, there is combined, when the respective enamel coating is burnt in, a glass/metal compound in which intermediate layers, so-called intermetallic phases, are formed between the glass material and the metal substrate. These ensure a particularly intensive adhesion of the coating to the metal. To this end, modern enamels are nowadays multi-material admixtures which, using their eutectic at low burning-in temperatures, achieve a very good mechanical hardness and chemical resistance. In this instance, enamel-coated workpieces can be processed, for example, by means of bending, sawing or drilling and can additionally be provided with functional, nanoscale sol-gel layers in order, for example, to supplement the hard scratch-resistant enamel layer with a temperature-resistant anti-adhesive effect.

From DE 10 2010 025 286 A1, it is further known that the inner faces of exhaust gas channels of light metal cast components, such as, for example, cylinder heads, for internal combustion engines can be effectively protected against thermal overloading by being at least partially covered with a coating which is formed from a glass material. The practical use of this proposal results in a particular challenge in that the coating on the one hand has to safely withstand the mechanical and thermal loads which occur during operation and, on the other hand, has to permit mechanical processing of portions of the respective component adjacent to the coated surface portion without the risk of the coating peeling.

An enamel coating which is further optimised in terms of its mechanical and thermal resistance can be produced using the enamel powder which is set out in DE 10 2013 108 428 A1 and WO 2015/018795 A1. The components thereof are combined in such a manner that the enamel coating which is produced therefrom in principle has a higher pressure resistance and tensile resistance than other coatings of this type known from the prior art. This known enamel powder is therefore particularly suitable for producing an enamel coating on a metal cast component which comprises light metal or a light metal alloy.

Practical tests have shown that the enamel or glaze coatings which are composed and produced in the manner explained above in principle comply with the expectations which have been set per se. However, it has been found that to this end, during the thermal processing of metal components which are provided with such coatings, particularly careful and cautious temperature control is required.

Against this background, the objective was to propose a metal component which is of the type mentioned in the introduction and in which there are no particular limitations with respect to the thermal processing and in which optimum protection of the faces which are highly loaded during use is still ensured.

There should also be set out a method which is suitable for producing such metal components.

With respect to the metal component, the invention has achieved this objective with a metal component provided with the features mentioned in claim 1.

The operationally reliable production of metal components of the type according to the invention can be carried out according to the invention by the method set out in claim 14.

Advantageous embodiments of the invention are set out in the dependent claims and are explained in detail below along with the general notion of the invention.

A metal component according to the invention for an internal combustion engine accordingly has a face which during use is thermally or mechanically more highly loaded than the environment thereof and which is at least partially covered with a glaze or enamel layer. According to the invention the glaze or enamel layer contains with respect to the enamel frit used to produce the enamel coating from 2 to 35% by weight of an admixture of particles which consist of at least one material from the group “glass, organic plastics materials, synthetically produced oxides and admixtures of such oxides, wherein the production of the oxides is optionally carried out by means of a melt”, which has a thermal expansion coefficient of a maximum of 50×10⁻⁷ K⁻¹ and a melting temperature of at least 500° C.

The term “glaze or enamel layer” includes according to the understanding of the invention layers which are formed from inorganic compounds which comprise oxides of the alkali and alkaline earth group which have melted together. These include SiO₂, Al₂O₃, B₂O₃, Li₂O, Na₂O, CaO, MgO and K₂O. In this instance, the layers may additionally contain inorganic or organic compounds in the form of fibres, such as, for example, SiC or C fibres, and other enamel-typical additives known to the person skilled in the art. During the production of the glaze or enamel coatings, the premelted compounds which are used as a frit are ground with water. Subsequently, the fibres are optionally added.

According to the invention, there are now additionally added to the slurry, preferably after the production thereof, particles which have a minimised thermal expansion coefficient at a maximised melting temperature. These particles comprise materials which belong to the group “glass, organic plastics materials, synthetically produced oxides and admixtures of such oxides, wherein the production of the oxides is optionally carried out by means of a melt”. The relevant materials are distinguished in that they have a very low maximum thermal expansion coefficient of a maximum of 50×10⁻⁷ K⁻¹ and a high melting temperature of at least 500° C. In this instance, for the particle admixture which is provided according to the invention, those materials are particularly suitable which have an expansion coefficient of a maximum of 25×10⁻⁷ K⁻¹, in particular a maximum of 10×10⁻⁷ K⁻¹. In materials which are suitable for the admixture powder of the type in question here, the expansion coefficient is in practice typically at least 0.5×10⁻⁷ K⁻¹, wherein minimum expansion coefficients of at least 2×10⁻⁷ K⁻¹ or at least 4×10⁻⁷ K⁻¹ are regularly encountered.

Powders which can be used for the purposes according to the invention must also have a high melting temperature. Melting temperatures of at least 900° C. have been found to be particularly suitable in this instance, wherein the melting temperature is optimally in the range from 1000 to 1400° C.

The quantity of admixture added according to the invention is determined relative to the weight of the enamel frit which is provided to form the enamel layer. That is to say, if the enamel or glaze coating is intended to comprise 100 grammes of enamel frit, according to the invention there are added to the slurry 2-35 grammes of powdered admixture of materials which are determined in accordance with the invention.

The slurry which is obtained in this manner is applied to the portion of the respective surface which is intended to be protected, dried at that location and burnt to form the respective glaze or enamel coating. The drying and the burning-in can be carried out in conventional manner by the metal component as a whole being brought to the required temperature. If this is achieved during the processing of the metal component, a heat which is present in the respective metal component for drying as a result of the method can be used for the drying and burning-in operation. This is particularly advantageous, for example, with cast components in which the cast component which is still hot from casting is coated in a manner according to the invention. Similar possibilities arise when the metal component is a hot-formed, in particular hot-forged component. The drying and burning-in can also be carried out during a thermal processing operation to which the metal component is subjected in order to adjust the mechanical and other properties thereof.

It has surprisingly been found with metal components according to the invention that the enamel or glass layer provided at that location, as a result of the admixtures which are additionally added according to the invention of particles of materials in which a particularly low thermal expansion coefficient is combined with a high melting temperature, is also insensitive with respect to temperature change when these temperature changes take place at high speed. Such extreme temperature changes occur, for example, during quenching of metal components after a thermal processing operation, when the metal components are quenched using a quenching medium, for example, water, spray or liquid nitrogen. In this instance, cooling rates of more than 2 K/s, typically at least 5 K/s are achieved, wherein a typical upper limit of the cooling rates achieved with water quenching or water spray is 30 K/s. It has been found that, even with the temperature shock which is linked with such a rapid quenching, secure adhesion of the coating on the respective metal substrate is ensured.

Cracks which may also inevitably occur in a coating according to the invention as a result of a rapid and extreme temperature change are repaired following a repeated heating operation so that, even with repeated temperature changes, there is no impairment of the protection and adhesion properties of the coating with respect to the initial state. Practical tests have shown in this instance that components which are coated according to the invention can be cooled beyond the quenching to ambient temperature, for example, using liquid nitrogen, to a temperature of up to −196° C. without any occurrence of damage as a result of which the protective action of the coating is impaired in a lasting manner.

The recipe according to the invention of an enamel or glaze coating consequently enables such coatings to be produced and permanently obtained in a reliable manner on different metal materials. Accordingly, the invention is equally suitable for coating metal components, in particular cast components, of an iron material and for coating components which are produced from a light metal cast material, in particular an Al-cast material. In this instance, the adhesion of the coating to the respective material substrate is ensured by the reactivity between the base material and the enamel. The admixture which is additionally added according to the invention then ensures the required thermal shock resistance.

The admixture which is provided according to the invention has a particularly favourable effect when the content thereof with respect to the weight of enamel frit added to the slurry is at least 8% by weight, in particular at least 10% by weight. An optimal use of the properties of the particle powder added according to the invention is produced when the content of powder particles with respect to the weight of the enamel frit is a maximum of 30% by weight, in particular a maximum of 20% by weight.

In this instance, it has been found that an optimum distribution of the particles of the admixture in the slurry which is intended to be applied to the surface portion to be protected and a correspondingly optimum distribution and action in the enamel or glaze coating which is produced on the metal component are produced when the enamel or glaze layer or the slurry which is applied to the surface portion to be protected in the context of the method according to the invention contains pre-ground ceramic particles as an admixture. In particular, the particles have a positive effect here with respect to the thermal shock resistance of the enamel or glaze coating, which are present in a grinding fineness of 5-150 μm in the coating or the slurry applied.

An enamel or glaze layer produces its protective effect in a particularly effective manner when it is from 50-1000 μm thick, wherein an optimum action with at the same time optimised resistance of the layer is produced with a layer thickness of from 300-500 μm.

An excessive heating of the surface portion to be protected in each case can be reliably avoided by the enamel or glaze layer applied according to the invention having a thermal conductivity of less than 10×10⁻⁷ K⁻¹, wherein coatings with a thermal conductivity of less than 4×10⁻⁷ K⁻¹ have been found to be particularly advantageous in this regard. This applies in particular when the layer thicknesses of the coating according to the invention are in the range mentioned above.

The particles which are added according to the invention as an admixture may but do not have to comprise a homogeneous material. Instead, admixtures of such materials can be used as additives when these materials comply with the requirements prescribed according to the invention in terms of the thermal expansion coefficients and melting temperatures thereof.

Suitable materials for the particles which are added as an admixture to the coating according to the invention include in principle fire-resistant materials and in particular material particles from the group of magnesium aluminium silicates, lithium glass ceramics, quartz glasses, zirconium aluminium silicates or aluminosilicates.

The materials of the system MgO—Al₂O₃—SiO₂ (magnesium aluminium silicates) in question include in particular cordierite (M₂A₂S₅), aluminosilicates include in particular mullite (A₃S₂). Particles which comprise components of these systems can also be used, in particular particles of SiO₂ with amorphous or crystalline structure or Al₂O₃ with corundum modification.

From the zirconium aluminium silicates (ZrO₂—Al₂O₃—SiO₂) it is possible to mention in particular zirconium mullite (ZSA₃) or zirconia (ZS) as being materials which are particularly suitable for the purposes according to the invention.

Lithium ceramics or technical glasses, such as quartz glass, also have minimised expansion coefficients with high melting temperatures and can be added to the enamel in sufficiently comminuted form for the purposes according to the invention.

Of course, admixtures of the materials mentioned above can also be used with other materials for the purposes according to the invention when they comply with the requirements set out by the invention in terms of their expansion coefficients and their melting temperature. These include, for example, porcelain materials, which have a typical thermal expansion coefficient of a maximum of 0.5×10⁻⁷ K⁻¹ and a particularly high melting temperature of more than 1600° C.

Known oxide ceramics have a typical expansion coefficient of 8×10⁻⁷ K⁻¹ at melting temperatures in the region of 900° C.

The admixtures provided according to the invention can be added in commercially available form. The materials which are mentioned here and which can be used to produce the admixture are known to the person skilled in the art as are the methods for suitable comminution of the relevant materials (see, for example, Gerald Routschka, Hartmut Wuthnow [Ed.] “Praxishandbuch Feuerfeste Werkstoffe” (Practical Handbook Fire-resistant Materials), 5th edition, Vulkan Verlag, ISBN-13: 978-3802731617).

The organic plastics materials which can be used for the purposes according to the invention are explained, for example, in the AVK—Industrie Vereinigung Verstärkte Kunststoffe e.V. (Federation of Reinforced Plastics) “Handbuch Faserverbundkunststoffe: Grundlagen, Verarbeitung, Anwendungen”, (Handbook of Fibre Composite Plastics Materials: Principles, Processing, Applications), Vieweg+Teubner Verlag; Edition: 3., completely revised edition 2010 (27 Oct. 2009).

The coating according to the invention is particularly suitable for protecting those faces of a metal component which are thermally loaded during use by means of a gas which is formed therein or which flows therethrough. Such faces may be provided in a space or a channel of the metal component, in which correspondingly hot gas is formed during use or through which hot gas flows during use. Such relationships are produced, for example, in metal components, in particular cast components, for internal combustion engines in the region of the combustion chambers and the exhaust channels, but also in the region of turbocharger housings, pistons and other components of an internal combustion engine which are subjected to the heat of an exhaust gas flow. In this instance, it is possible, for example, for the gas-discharging manifolds of the exhaust gas system of an internal combustion engine to be formed from a sheet metal material. In this instance, an enamel or glaze coating which has been produced according to the invention is also found to be very favourable with respect to protection from excessive local heating.

However, precisely with such components, it may be advantageous to protect not only the inner faces which are loaded with hot gas with a coating according to the invention. Thus, it may also be advantageous to coat external surface portions of the respective metal component in a manner according to the invention when particular mechanical or thermal loads occur at the location. The glaze or enamel coating according to the invention may also constitute a corrosion protection, which protects the use against a chemically aggressive fluid or gaseous medium.

The application which is typical of the invention is a cylinder head which is produced as a cast component for an internal combustion engine. The invention is also equally suitable for a housing for a turbocharger which is arranged in the exhaust gas flow of an internal combustion engine and whose channel through which the exhaust gas flows is coated in a manner according to the invention.

As a result of the coating according to the invention, the output of an internal combustion engine can be decisively increased. To this end, the regions which surround the combustion chamber, such as pistons, block bearing surface and cylinder head combustion chamber roof faces, can be coated in a manner according to the invention. As a result of the reduction of the thermal losses which are achieved in this manner, the objective of an “adiabatic engine” moves a step closer. Furthermore, it may be advantageous to coat the inlet channels of the internal combustion engine at least partially according to the invention so that the incoming air is shielded with respect to the high temperature of the cast material which surrounds the inlet channel in each case when engines are highly loaded and thus a higher degree of loading and a consequently increased degree of engine efficiency is achieved. A coating according to the invention can also contribute to the reduction of radiation losses of engines and other thermal installations as a result of the low thermal conductivity.

Finally, as a result of the invention, the reaction gases which are produced during the combustion process can be directed with greater thermal efficiency into the following processes.

If the coating according to the invention is intended to be constructed as an enamel coating, an enamel as described in DE 10 2013 108 429 A1 and whose content is hereby incorporated in the disclosure of the present application is particularly suitable as a basis for this. The enamel powder set out in the relevant German patent application is particularly suitable for coating metal surfaces which are subjected to high thermal and mechanical loads during operation and is present as an admixture which contains 100 parts of a glass powder, optionally 10-22 parts of coarse glass grains, which are larger than the particles of the glass powder, from 0.1 to 7.5 parts of ceramic fibres, glass fibres or carbon fibres and alternatively to each other or in combination with each other 10-21 parts of a powdered oxidic compound of a light metal or 1-5 parts of a powder of a heavy metal. By the admixture provided according to the invention being added to a slurry formed from this admixture, there is obtained a coating which reliably complies with even the highest requirements in terms of the protective action and resistance thereof.

When the term “parts” is used in this instance as a metering measure, this is intended to be understood to mean that the quantity of the respective component added to the enamel powder is measured using a unit of measurement, which is the same for all components, and that the “parts” which are provided according to the invention in each case for the individual components refer to the respective multiple of this unit of measurement.

In accordance with the above explanations, a method according to the invention for producing a metal component which has a face which during use is thermally or mechanically more highly loaded than the environment thereof and which is at least partially covered with a glaze or enamel layer, comprises the following operating steps:
providing the metal component;
providing an enamel or glaze slurry, which with respect to the enamel frit used to produce the enamel or glaze coating contains from 2.0 to 35% by weight of an admixture of particles which consist of least one material from the group “glass, organic plastics materials, synthetic oxide admixtures or melts” which has a thermal expansion coefficient of a maximum of 50×10⁻⁷ K⁻¹ and a melting temperature of at least 500° C.;
applying the enamel or glaze slurry to the respective portion of the face of the metal component;
drying and burning-in the applied enamel or glaze slurry;
thermally processing the metal component, wherein the thermal processing optionally comprises cooling at a cooling speed which is higher than the cooling speed which is achieved with a cooling in static air, in particular with a cooling in moving air;
optional mechanical processing of the enamel or glaze layer which is formed from the enamel or glaze slurry.

The non-sensitivity of the coating which is applied according to the invention in this instance enables a wide range of thermal processing and other methods which are required to produce a component with optimum properties. For example, the metal component can be locally heated in order to burn-in the enamel or glaze slurry which has been applied in the region of the enamel or glaze slurry coating applied and can be maintained at a lower temperature outside this region so that there is no impairment of the metal component substrate as a result of the burning-in processing. The coating according to the invention can also be reprocessed mechanically, for example, by means of grinding.

The invention is suitable in this instance for any metal components which are subjected to the conditions of use mentioned above. These include both metal components which are produced on the basis of a sheet by means of shaping and metal components which are produced using an original shaping method, for example, casting or forging.

With the invention, there is consequently provided a metal component and a method for the production thereof which enable precise production and which in particular enable the coating of internal hollow spaces in this case. A particular advantage of the coating according to the invention is that it provides highly effective protection against thermal, corrosive or mechanical loads, without additional components having to be provided for this purpose. Problems of tolerance, as would be the case with cast shaped components, are avoided in this manner.

The minimised layer thicknesses which are made possible by the invention with at the same time an optimised protection function enable a configuration and construction of the metal component which are optimised in terms of saving weight even in the regions in which high loads are anticipated.

The burning-in of the coating may be carried out in a particularly economical manner during a thermal processing operation, in particular a solution annealing process, as conventionally carried out during the production of cast components for internal combustion engines.

As a result of the protection which is ensured by the coating according to the invention, less high demands can be placed on the thermal, corrosive or mechanical resistance of the metal material. This enables more cost-effective and generally less resilient materials to be used.

The invention is explained in greater detail below with reference to embodiments.

### EXAMPLE 1

A cylinder head which is cast from a conventional Al-cast alloy for a highly compressed diesel engine is annealed at 500° C. for a time of 30 minutes and subsequently cooled to ambient temperature.

Subsequently, on the surface portions which are intended to be provided with an enamel coating, the oxidic reaction products, in particular Al₂O₃ and the other impurities which have been produced during the annealing operation, are eliminated. To this end, the respective surfaces are pickled with dilute nitric acid HNO₃. Subsequently, the cylinder head is flushed in order to neutralise the previously pickled surface first with dilute alkali lye and then with water. After the drying, there is applied a slurry which has been mixed in accordance with the following recipe:

100 parts of enamel frit
3 parts of boric acid
3 parts of caustic potash
3 parts of water glass
55 parts of water

In order to measure the “parts” mentioned, the same hollow measure was used in each case. That is to say, 100 hollow measure units of enamel frit are mixed in each case with three hollow measure units of boric acid, caustic potash and water glass and with 55 hollow measure units of water. In this instance, the overall weight of the added enamel frit was established.

This admixture was ground in a porcelain mill.

After the grinding operation, there was added to the admixture obtained with respect to the weight of the enamel frit contained in the admixture 20% by weight of cordierite in powder form which has a thermal expansion coefficient of typically 10-30 10⁻⁷ K⁻¹. The admixture formed in this manner was then ground again, until an admixture with uniform grain size was obtained.

The channels of the cylinder head whose surfaces are intended to be coated with the enamel layer were then flushed with the slurry in order to wet the relevant surface portions with the slurry.

Drying was followed by a burning-in operation, in which the cylinder head was maintained for a time of 50 minutes at a temperature of 510° C.

The enamel layer obtained in this manner had, even with extreme temperature changes, a good adhesion to the Al-cast substrate and a high level of insensitivity with respect to the formation of cracks.

### EXAMPLE 2

A turbocharger housing which has also been cast from an Al-cast alloy for an internal combustion engine was annealed at a temperature of 500° C. for 30 minutes and subsequently cooled to ambient temperature. The inner surfaces of the turbocharger housing which are intended to be coated with an enamel layer were subsequently freed from oxidic adhesions and other impurities by means of sandblasting.

For the coating, a slurry was prepared which was mixed from:

100 parts of enamel frit
4 parts of boric acid
4 parts of caustic potash
4 parts of water glass
55 parts of water.

For the measurement of the “parts” mentioned, the procedure is as explained in relation to Example 1. The overall weight of the enamel frit added to the slurry admixture was also established in this instance.

The slurry admixture formed from the components mentioned was also ground in a porcelain mill to the desired grain fineness.

After the grinding operation, there were added to the admixture with respect to the weight of the enamel frit contained in the admixture 17.5% by weight of quartz glass powder with a thermal expansion coefficient of typically 5.4 10⁻⁷ K⁻¹. The admixture formed in this manner was then ground again until an admixture with uniform grain size was obtained.

The slurry obtained was then poured into the turbocharger housing and by means of rotation of the housing distributed in a uniform manner on the surfaces which are intended to be coated.

Drying was followed by a burning-in operation, in which the turbocharger housing was maintained for a time of 45 minutes at a temperature of 525° C.

The enamel layer obtained in this manner had, even with extreme temperature changes, a good adhesion to the Al-cast substrate and a high level of insensitivity with respect to the formation of cracks.

1.-15. (canceled)

16. A metal component comprising a face at least partially covered with a glaze or enamel layer, wherein during use, the face is thermally or mechanically more highly loaded than the remainder of the component and wherein the glaze or enamel layer comprises an admixture of particles of at least one material selected from the group consisting of glass, organic plastics materials, synthetically produced oxides and admixtures of such oxides, and the particles have a maximum thermal expansion coefficient of 50×10⁻⁷ K⁻¹ and a melting temperature of at least 500° C., and wherein, the glaze or enamel layer comprises, with respect to the frit used to produce the glaze or enamel layer, 2 to 35% by weight of the admixture.

17. The metal component according to claim 16, wherein the glaze or enamel layer comprises, with respect to the frit used to produce the glaze or enamel layer, 10 to 30% by weight of the admixture.

18. The metal component according to claim 16, wherein the admixture comprises pre-ground ceramic particles.

19. The metal component according to claim 18, wherein the particle size of the ceramic particles is from 5 to 150 μm.

20. The metal component according to claim 16, wherein the admixture contains magnesium aluminium silicate particles.

21. The metal component according to claim 16, wherein the admixture contains lithium glass ceramic particles.

22. The metal component according to claim 16, wherein the admixture contains quartz glass particles.

23. The metal component according to claim 16, wherein the admixture contains zirconium aluminium silicate particles.

24. The metal component according to claim 16, wherein the admixture contains aluminosilicate particles.

25. The metal component according to claim 16, wherein the enamel or glaze layer is 50 to 1000 μm thick.

26. The metal component according to claim 16, wherein the enamel or glaze layer has a thermal conductivity of less than 25×10⁻⁷ K⁻¹.

27. The metal component according to claim 16, wherein the face which is at least partially coated with the enamel or glaze layer surrounds a space or channel of the metal component which is thermally loaded during use by a gas which is formed therein or which flows therethrough.

28. The metal component according to claim 16, wherein the metal component is a cast component which is cast from a cast metal.

29. A method for producing a metal component comprising a face at least partially covered with a glaze or enamel layer, wherein during use, the face is thermally or mechanically more highly loaded than the remainder of the component, the method comprising:
providing the metal component;
providing an enamel or glaze slurry comprising a frit and, with respect to the frit, 2.0 to 35% by weight of an admixture of particles of at least one material selected from the group consisting of glass, organic plastics materials, synthetically produced oxides and admixtures of such oxides, wherein the particles have a maximum thermal expansion coefficient of 50×10⁻⁷ K⁻¹ and a melting temperature of at least 500° C.;
applying the enamel or glaze slurry to at least a portion of the face of the metal component;
drying and burning-in the applied enamel or glaze slurry;
thermally processing the metal component.

30. The method according to claim 29, wherein burning-in of the enamel or glaze slurry which has been applied to the metal component comprises locally heating the metal component in the region where the enamel or glaze slurry has been applied at a first temperature and keeping the portions of the metal component outside of this region at a second temperature, wherein the second temperature is lower than the first temperature.

31. The method of claim 29, wherein the thermal processing comprises cooling at a cooling rate that is higher than a cooling rate achieved by cooling in static air.

32. The method of claim 31, wherein in the thermal processing comprises cooling in moving air.

33. The method of claim 29, wherein after thermal processing, the enamel or glaze layer formed from the enamel or glaze slurry is mechanically processed.
